(19) United States
(12) Patent Application Publication
(10) Pub. No.: US 2016/0334261 A1
(43) Pub. Date: Nov. 17, 2016

(54) MEDICAL RESERVOIR LEVEL SENSOR

(71) Applicant: Mayo Foundation for Medical Education and Research, Rochester, MN (US)

(72) Inventor: Donald S. Wilson, III, Phoenix, AZ (US)

(73) Assignee: Mayo Foundation for Medical Education and Research, Rochester, MN (US)

(21) Appl. No.: 15/112,516

(22) PCT Filed: Dec. 19, 2014
(86) PCT No.: PCT/US2014/071395

§ 371 Date: Jul. 19, 2016

Related U.S. Application Data
(60) Provisional application No. 61/929,728, filed on Jan. 21, 2014.

(51) Int. Cl. G01F 23/24; F04B 49/20; F04B 49/06

(52) U.S. Cl. CPC G01F 23/241; F04B 49/06; F04B 49/20; F04B 2207/00

(57) ABSTRACT

Devices can be used for detecting a level of a fluid in a medical fluid reservoir and for controlling the level. For example, this documents describes devices and methods for controlling the flow rate of a medical pump, and/or the occlusion amount of a medical fluid tube, based on the detected level of fluid in the medical reservoir.

### CROSS-REFERENCE TO RELATED APPLICATIONS

This application claims the benefit of U.S. Provisional Application Ser. No. 61/929,728, filed Jan. 21, 2014. The disclosure of the prior application is considered part of (and is incorporated by reference in) the disclosure of this application.

### BACKGROUND

1. Technical Field

This document relates to devices for detecting a level of a fluid in a medical fluid reservoir, and methods for controlling the flow rate of a medical pump, and/or the percentage of venous line occlusion of an electronic venous occluder (EVO), based on the detected level of fluid in the medical reservoir.

2. Background Information

Fluid systems commonly include components such as tubing, pumps, reservoirs, heat exchangers, sensors, filters, valves, and the like. Such components can be connected together in a network to define a fluid flow path. Some fluid systems are open systems, meaning that the fluid flows through the network once and then exits the network. Other fluid systems are closed systems, meaning that the fluid recirculates within the network of components. Fluids are caused to flow in the fluid system using fluid pressure differentials. In some cases, a pump is used to create a pressure differential that causes the fluid to flow within the fluid system.

Reservoirs are used as components of fluid systems for various purposes. In some cases, reservoirs are used for accumulation or storage of the fluid. In some cases, the storage of a fluid in a reservoir is used to facilitate a steady outgoing flow of the fluid, despite having an unsteady incoming flow of the fluid. Some reservoirs are completely filled with the fluid, while other reservoirs include an airspace above the level of the fluid in the reservoir.

Fluid systems are often used in a medical context. Some examples of fluid systems used in the medical context include respiratory systems, anesthesia systems, infusion pump systems, blood transfusion circuits, kidney dialysis systems, extracorporeal membrane oxygenation (ECMO) systems, extracorporeal circuits for heart/lung bypass, and the like. Some such medical fluid systems include the use of medical fluid reservoirs. Detection of the level of fluid in the medical fluid reservoir can be useful for various purposes. In some circumstances, the detection of the level of fluid in a medical fluid reservoir can be important for avoiding undesirable consequences that may be risky or inherently detrimental to the health of a patient undergoing treatment using the medical fluid system.

As per Standard 7.9 of the AmSECT 2013 reference: “The percentage of venous line occlusion of the venous occluder shall be monitored continually during CPB.” An example of an EVO system is provided in U.S. Pat. No. 8,491,543. Manufacturers of equipment for heart bypass surgery, such as Terumo Cardiovascular Systems and Sorin, market such EVO systems.

### SUMMARY

This document provides devices for detecting a level of a fluid in a medical fluid reservoir, and methods for controlling the flow rate of a medical pump and/or the percentage of venous line occlusion of the EVO based on the detected level of fluid in the medical reservoir.

In general, one aspect of this document features a medical fluid reservoir. The medical fluid reservoir comprises a reservoir shell. The reservoir shell defines an interior space that is configured to receive a medical fluid. The medical fluid reservoir further comprises one or more level sensors that are at least partially disposed in the interior space of the reservoir shell. The level sensor(s) comprises one or more wires that are configured to be immersed in the medical fluid such that a resistivity of the wire(s) is indicative of a level of the medical fluid in the interior space of the medical fluid reservoir.

In various implementations of the medical fluid reservoir, the wire may be a loop and an amount of the wire loop that is immersed in the medical fluid may correspond to the resistivity of the wire loop. In some embodiments, the amount of the wire loop that is immersed in the medical fluid may be inversely proportional to the resistivity of the wire loop. Optionally, the medical fluid can be an electrolyte in some implementations. For example, in some implementations the medical fluid can comprise human blood.

In another general aspect, this document features an embodiment of a medical fluid system. The medical fluid system comprises a reservoir shell defining an interior space that is configured to receive a medical fluid. The medical fluid system also comprises a level sensor that is at least partially disposed in the interior space. The level sensor may comprise one or more wires that are configured to be immersed in the medical fluid such that a resistivity of the wire(s) is indicative of a level of the medical fluid in the interior space. The medical fluid system also comprises a pump system that is configured to pump the medical fluid into or out of the interior space. A speed of the pump system may be responsive to a pump speed adjustment input signal. The medical fluid system may also comprise an EVO system that is configured to regulate the flow rate of the medical fluid into the interior space. The EVO system may be responsive to a percent venous line occlusion adjustment input signal.

In various implementations of the medical fluid system, the one or more wires may each be a loop, and an amount of the wire loop that is immersed in the medical fluid may correspond to the resistivity of the wire loop. Optionally, the amount of the wire loop that is immersed in the medical fluid may be inversely proportional to the resistivity of the wire loop. In some implementations, in response to a decreased resistivity of the wire loop, the pump speed adjustment input signal causes the speed of the pump system to increase. In some implementations, in response to an increased resistivity of the wire loop, the pump speed adjustment input signal causes the speed of the pump system to decrease. In some implementations, in response to a decreased resistivity of the wire loop, the percent venous line occlusion adjustment input signal causes the percent occlusion of the EVO to increase. In some implementations, in response to an increased resistivity of the wire loop, the percent venous line occlusion adjustment input signal causes the percent occlusion of the EVO to decrease.

In another general aspect, this document features a method of controlling a medical pump and/or an EVO system. The method comprises measuring a resistivity of a level sensor that is disposed in an interior space of a medical fluid reservoir. The resistivity is inversely proportional to a level of a medical fluid in the interior space. The method also comprises, comparing the measured resistivity to a pre-established value or range of resistivity. The method also comprises, in response to the comparison, sending a pump speed adjustment signal to a pump speed control system that controls the speed of a pump that propels the medical fluid into or out of the interior space and sending a percent venous line occlusion adjustment signal to an EVO control system that controls the EVO that regulates the flow rate of the medical fluid into or out of the interior space.

In various implementations of the method, when the comparison indicates that the measured resistivity is less than the pre-established value or range of resistivity, the pump speed adjustment signal may cause the pump to speed up and/or the EVO adjustment signal to increase the percentage of venous line occlusion to decrease blood flow in venous line. Optionally, when the comparison indicates that the measured resistivity is greater than the pre-established value or range of resistivity, the pump speed adjustment signal may cause the pump to slow down and the EVO adjustment signal to decrease the percentage of venous line occlusion to increase blood flow in the venous line. Further, when the comparison indicates that the measured resistivity is essentially equal to the pre-established value or range of resistivity, the pump speed adjustment signal may cause the pump to not speed up and may cause the pump to not slow down and the EVO adjustment signal may cause the percentage of venous line occlusion to not decrease and may cause the percentage of venous line occlusion to not increase the percent occlusion.

In another general aspect, this document features a medical fluid reservoir that includes a reservoir shell defining an interior space that is configured to receive a medical fluid, and two or more individual level sensors at least partially disposed in the interior space. Each of the two or more individual level sensors comprise a wire that is configured to be immersed in the medical fluid such that a resistivity of the wire is indicative of a level of the medical fluid in the interior space.

In various implementations of the reservoir, the wire may be a loop, and an amount of the wire loop that is immersed in the medical fluid may correspond to the resistivity of the wire loop. The amount of the wire loop that is immersed in the medical fluid may be inversely proportional to the resistivity of the wire loop. The medical fluid may be an electrolyte. The medical fluid may comprise human blood. The two or more individual level sensors may comprise three or more individual level sensors. The two or more individual level sensors may comprise five or more individual level sensors.

In another general aspect, this document features another method of controlling a medical pump and/or an EVO system. The method comprises: (a) measuring a resistivity of two or more individual level sensors at least partially disposed in an interior space of a reservoir containing a medical fluid, each of the two or more individual level sensors comprising a wire that is configured to be immersed in the medical fluid such that a resistivity of the wire is indicative of a level of the medical fluid in the interior space; (b) comparing the measured resistivity of adjacent individual level sensors of the two or more individual level sensors to determine a resistivity difference between adjacent individual level sensors; (c) comparing the determined resistivity difference between adjacent individual level sensors to a pre-established threshold value or range of resistivity; (d) determining the level of the medical fluid in the interior space based on a particular resistivity difference between adjacent individual level sensors being greater than the pre-established threshold value or range of resistivity; (e) in response to the determining, sending a pump speed adjustment signal to a pump speed control system that controls the speed of the medical pump that propels the medical fluid into or out of the interior space; and optionally (f) in response to the determining, sending a percent venous line occlusion adjustment signal to an EVO control system that controls the EVO that regulates the flow rate of the medical fluid into or out of the interior space.

In various implementations of the method, the wire may be a loop, and an amount of the wire loop that is immersed in the medical fluid may correspond to the resistivity of the wire loop. The amount of the wire loop that is immersed in the medical fluid may be inversely proportional to the resistivity of the wire loop. The medical fluid may be an electrolyte. The medical fluid may comprise human blood. The two or more individual level sensors may comprise three or more individual level sensors. The two or more individual level sensors may comprise five or more individual level sensors.

Particular embodiments of the subject matter described in this document can be implemented to realize one or more of the following advantages. In some medical procedure implementations, a medical reservoir level detection system can be used to automate the control of a pump and/or an EVO system, thereby reducing some of the necessity for on-going direct monitoring of the reservoir by a clinician operator. Accordingly, the clinician operator may be allowed to attend to other aspects of the medical procedure, thereby enhancing the efficiency of the clinical team. In some embodiments, the use of such automation can allow for the use of a smaller medical reservoir. In some such cases, the medical procedure can therefore be performed with less dilution of the patient's blood. Such improved devices and methods may enhance the overall medical procedure efficacy, improve patient safety, and reduce procedure costs.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description herein. Other features, objects, and advantages of the invention will be apparent from the description and drawings, and from the claims.

### DESCRIPTION OF THE DRAWINGS

FIG. 1 is a schematic diagram of patient undergoing a medical procedure using a fluid system including a fluid reservoir, in accordance with some embodiments provided herein.

FIGS. 2A-2B are cutaway views of an example level sensor mounted in a medical fluid reservoir, in accordance with some embodiments provided herein.

FIG. 3 is an example graph of level sensor resistance in comparison to reservoir volume.

FIG. 4 is flowchart of a method for controlling the speed of a pump and/or the percent occlusion by an EVO system in response to a level sensor signal, in accordance with some embodiments provided herein.

FIG. 5 is a cutaway view of another example level sensor system mounted in a medical fluid reservoir, in accordance with some embodiments provided herein.

Like reference numbers represent corresponding parts throughout.

### DETAILED DESCRIPTION

This document provides devices for detecting a level of a fluid in a medical fluid reservoir, methods for controlling the flow rate of a medical pump based on the detected level of fluid in the medical reservoir, and methods for controlling the percent occlusion of an EVO based on the detected level of fluid in the medical reservoir. The devices and methods provided herein are described in the exemplary context of a blood reservoir used for a heart/lung bypass procedure. However, it should be understood that the devices and methods provided herein may be applied in other types of medical fluid systems that include the use of a reservoir.

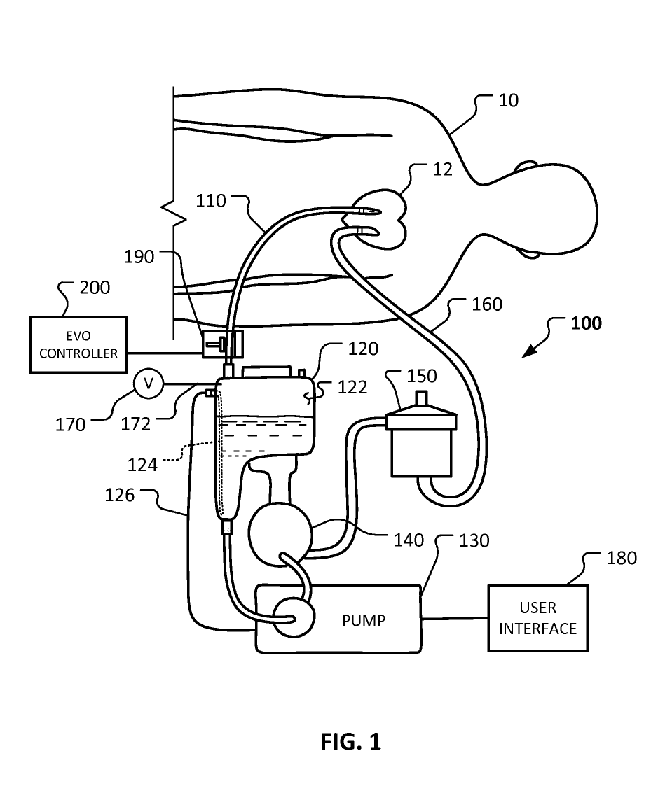

Referring to FIG. 1, a patient 10 can receive a medical treatment while using a medical fluid system 100. In this illustrative example, the patient 10 is undergoing a heart bypass procedure using an extracorporeal blood flow circuit 100. The circuit 100 is connected to the patient 10 at the patient's heart 12 (e.g., the right atrium). Blood from the patient 10 is extracted from the patient 10 at the patient's heart 12; the blood is circulated through the circuit 100; and the blood is then returned to the patient's heart 12 (e.g., at the ascending aorta).

The extracorporeal blood flow circuit 100 includes, at least, a venous tube 110, a blood reservoir 120, a pump 130, an oxygenator/heat exchanger 140, an arterial filter 150, an arterial tube 160, and a user interface 180. The venous tube 110 is in physical contact with the heart 12 and in fluid communication with the venous side of the circulatory system of the patient 10. The venous tube 110 is also in fluid communication with an inlet to the reservoir 120. An outlet from the reservoir 120 is connected by tubing to an inlet of the pump 130. The outlet of the pump 130 is connected to tubing to an inlet of the oxygenator/heat exchanger 140. The outlet of the oxygenator/heat exchanger 140 is connected by tubing to an inlet of the arterial filter 150. An outlet of the arterial filter 150 is connected to the arterial tube 160. The arterial tube 160 is in physical contact with the heart 12 and in fluid communication with the arterial side of the circulatory system of the patient 10. The user interface 180 can include user input and output devices that are used by the clinician operator to properly operate the extracorporeal blood flow circuit 100.

Briefly, the extracorporeal blood flow circuit 100 operates by removing venous blood from the patient 10 via the venous tube 110. Blood from the venous tube 110 is deposited in the reservoir 120. At least some amount of blood is intended to be maintained in the reservoir 120 at all times during the medical procedure. Blood from the reservoir 120 is drawn from the reservoir 120 by the pump 130. The pump 130 can be operated at various speeds which correspond to various flow rates of blood exiting from the reservoir 120. The pressure generated by the pump 130 propels the blood through the oxygenator/heat exchanger 140. In the oxygenator/heat exchanger 140 the venous blood is enriched with oxygen and adjusted to a desired temperature. The oxygen-rich arterial blood exits the oxygenator/heat exchanger 140, travels through the arterial filter 150, and is injected into the patient's heart 12 by the arterial tube 160.

As described above, the venous blood flows (drains) from the heart 12 to the reservoir 120. In some implementations, the venous blood drainage from the heart 12 to the reservoir 120 occurs primarily as a result of gravity. In such gravity drainage implementations the reservoir 120 is positioned at a lower elevation than the heart 12. In result, the blood naturally flows ‘downhill’ from the heart 12 to the reservoir 120. In some implementations, a vacuum is drawn in the airspace 122 of the reservoir 120 to assist with the drainage from the heart 12 to the reservoir 120. This technique is known as vacuum assisted venous drainage (VAVD). During VAVD procedures, the venous drainage is assisted by placing the reservoir 120 under a negative pressure (vacuum) in relation to the ambient pressure. For example, in some implementations a negative pressure is achieved within the airspace 122 using a vacuum source 170 that is connected to the reservoir 120 via a vacuum line 172. To maintain an effective level of vacuum in the airspace 122 when using VAVD, the reservoir 120 is sealed in an essentially airtight manner.

As described above, the venous blood flows (drains) from the heart 12 to the reservoir 120 through the venous tube 110. In some implementations, an EVO 190 provides precise, controlled and ergonomic operation of venous blood flow during cardiopulmonary bypass. The venous tube 110 passes through the EVO 190. The EVO 190 is adjusted by an EVO controller 200. The EVO 190 regulates the venous blood flow (drainage) from the heart 12 to the reservoir 120 by varying the percent of occlusion placed on the venous tube 110. As the percent venous occlusion increases the internal diameter of the venous tube 110 decreases and venous blood flow (drainage) from the heart 12 to the reservoir 120 decreases. As the percent venous occlusion decreases the internal diameter of the venous tube 110 increases and venous blood flow (drainage) from the heart 12 to the reservoir 120 increases.

The flow of blood through the extracorporeal blood flow circuit 100 is intended to be essentially continuous while the medical procedure is taking place. Within that overall context, an accumulation of blood exists in the reservoir 120 during the procedure. The accumulation of a certain amount of blood in the reservoir 120 is advantageous in some circumstances.

The accumulation of blood within the reservoir 120 serves multiple purposes. For example, in one aspect the accumulation of blood in the reservoir 120 provides a buffer amount to help ensure a continuous flow of oxygenated blood to the patient 10, even in the event that blood flow to the reservoir 120 is interrupted. For example, in some cases a clinician operator of the extracorporeal blood flow circuit 100 may endeavor to maintain an amount of blood in the reservoir that allows for about 12 to 15 seconds of runtime (blood flow to the patient 10) in the event that no more blood is added into the reservoir 120. In another example aspect, the reservoir 120 allows the venous blood to deaerate. The deaeration of the venous blood takes place by allowing air bubbles in the blood to escape the blood and flow into the air. For at least that reason, an airspace 122 is maintained in the reservoir 120.

To assist the clinician operator (e.g., perfusionist) of the extracorporeal blood flow circuit 100 to maintain a desired amount of accumulated blood in the reservoir 120, a reservoir level sensor 124 in accordance with the present disclosure can be provided. The level sensor 124 is responsive to the level of blood in the reservoir 120, That is, the level sensor 124 provides an indication of the level of blood in the reservoir 120. The level sensor 124 can be in electrical communication with the control system for the pump 130 and/or the user interface 180 via an electrical cable 126.

The indication of the level of blood in the reservoir 120 provided by the level sensor 124 can be used to control the speed of the pump 130 in some embodiments. For example, if the level sensor 124 indicates that the level of blood in the reservoir 120 is above a set point (or set range), the indication can be used to increase the flow rate of the pump 130. Such an increased flow rate will tend to cause the level of blood in the reservoir 120 to be reduced. Conversely, if the level sensor 124 indicates that the level of blood in the reservoir 120 is below a set point (or set range), the indication can be used to decrease the flow rate of the pump 130. Such a decreased flow rate will tend to cause the level of blood in the reservoir 120 to be increased.

The indication of the level of blood in the reservoir 120 provided by the level sensor 124 can be used to control the percent venous occlusion of the EVO 190 in some embodiments. For example, if the level sensor 124 indicates that the level of blood in the reservoir 120 is above a set point (or set range), the indication can be used to increase the percent venous occlusion of the EVO 190 thereby decreasing venous blood drainage to the reservoir 120. Such a decreased venous blood flow drainage rate will tend to cause the level of blood in the reservoir 120 to be reduced. Conversely, if the level sensor 124 indicates that the level of blood in the reservoir 120 is below a set point (or set range), the indication can be used to decrease the percent venous occlusion of the EVO 190 thereby increasing venous blood drainage to the reservoir 120. Such an increased venous blood flow drainage rate will tend to cause the level of blood in the reservoir 120 to be increased.

In some embodiments, the indication of the level of blood in the reservoir 120 provided by the level sensor 124 can be used to trigger alerts or alarms for receipt by the clinician operator. Such alerts or alarms can be provided via the user interface 180. Such alerts or alarms can be provided in lieu of, or in addition to, changing the speed of the pump 130 and/or changing the occlusion of the EVO 190.

In some embodiments, system parameters can be established whereby the automated responsiveness of the pump 130 and/or EVO 190, as described above, are further defined and/or controlled. For example, in some embodiments the aggressiveness (e.g., the pump gain/acceleration) of the pump speed and EVO occlusion changes can be selectively programmed into the system parameters. In another example, maximum or minimum pump speeds and EVO occlusion can be selectively programmed into the system parameters. In a further example, alarm limits can be selectively programmed into the system parameters. It is also envisioned that other such system parameters can also be selectively programmed into the system parameters.

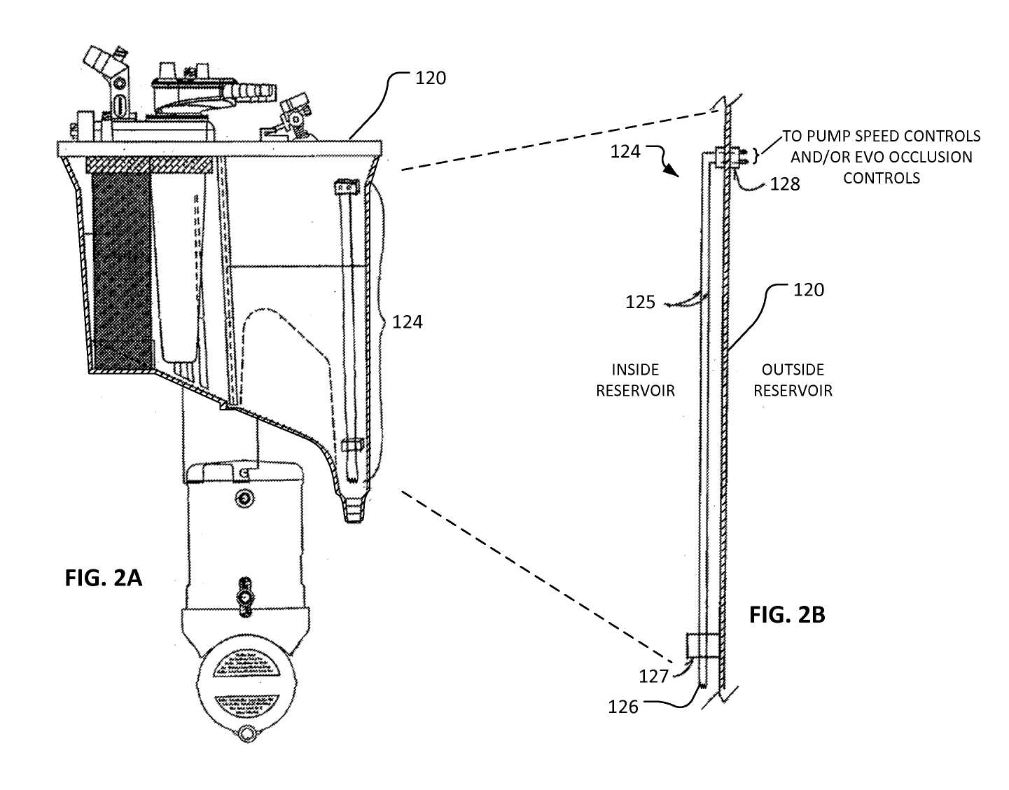

Referring now to FIGS. 2A and 2B, in some embodiments the level sensor 124 is configured to be at least partially within the interior of the reservoir 120. In that configuration, at least some of the level sensor 124 can be in direct contact with the liquid contents of the reservoir 120 (such as blood, saline, or other medical fluids). The reservoir of FIGS. 2A and 2B is shown in a partial cross-sectional view to provide visualization of the interior of the reservoir 120.

In the depicted embodiment, the level sensor 124 includes an electrically conductive/resistive wire loop 125, an optional resistor 126, one or more insulative supports 127, and a connector 128. When the reservoir 120 is in use, the connector 128 is coupled to a complementary connector (not shown) and a cable (e.g., cable 126 of FIG. 1) that is connected to a pump speed controller (e.g., pump 130 or user interface 180 and/or EVO Controller 200 or user interface 180 of FIG. 1).

The conductive wire loop 125 has a known resistivity per unit length. Therefore, the greater the length of the wire loop 125, the greater the electrical resistivity of the wire loop 125, as measured at the connector 128. It should be understood from the description provided herein that the portion of the wire loop 125 that is configured for contact with the liquid contents of the reservoir 120 does not include an insulative covering in some embodiments.

In use, an electrolytic liquid (e.g., blood, saline, etc.) may be partially filling the reservoir 120. In that case, a lower portion of the level sensor 124 may be immersed in the liquid of the reservoir 120, while an upper portion of the level sensor 124 is essentially dry (at least not immersed in the liquid of the reservoir 120). The resistivity of the wire loop 125 as measured at the connector 128 will then reflect the level of liquid in the reservoir 120 when the liquid is electrically conductive (at least more conductive than the wire loop 125). That is the case because the path of least resistance of the wire loop 125 (as measured at the connector 128) will be through the upper dry portion of the wire loop 125 and across the surface of the electrolytic liquid in the reservoir 120 between the wire loop 125. Therefore, the higher the level of liquid in the reservoir 120, the lower the resistance of the level sensor 120 as measured at the connector 128. The highest level of resistance through the wire loop 125 occurs when the wire loop 125 is dry. To ensure that the liquid's electrical conductivity is less than the wire loop 125, in some embodiments an optional resistor 126 can be placed within the wire loop 125, for example at the level of the reservoir's 120 lowest volume. However, in some embodiments no such resistor is included. In some embodiments, the resistor 126 can have a resistance of about 4.5 kΩ. In other embodiments, the resistor 126 may have greater or lower resistance levels as appropriate taking into account the resistance of the wire of the wire loop 125, for example.

A relationship between the resistance of the level sensor 120 and the level of liquid in the reservoir 120 can therefore be established. In this example, the amount of the wire loop 125 that is immersed in the medical fluid is inversely proportional to the resistivity of the wire loop 125 as measured at connector 128. That is, as more length of the wire loop 125 is immersed, the resistance of the wire loop 125 will be lessened. In result, by knowing the resistance of the level sensor 120, the level of the liquid in the reservoir 120 can be determined

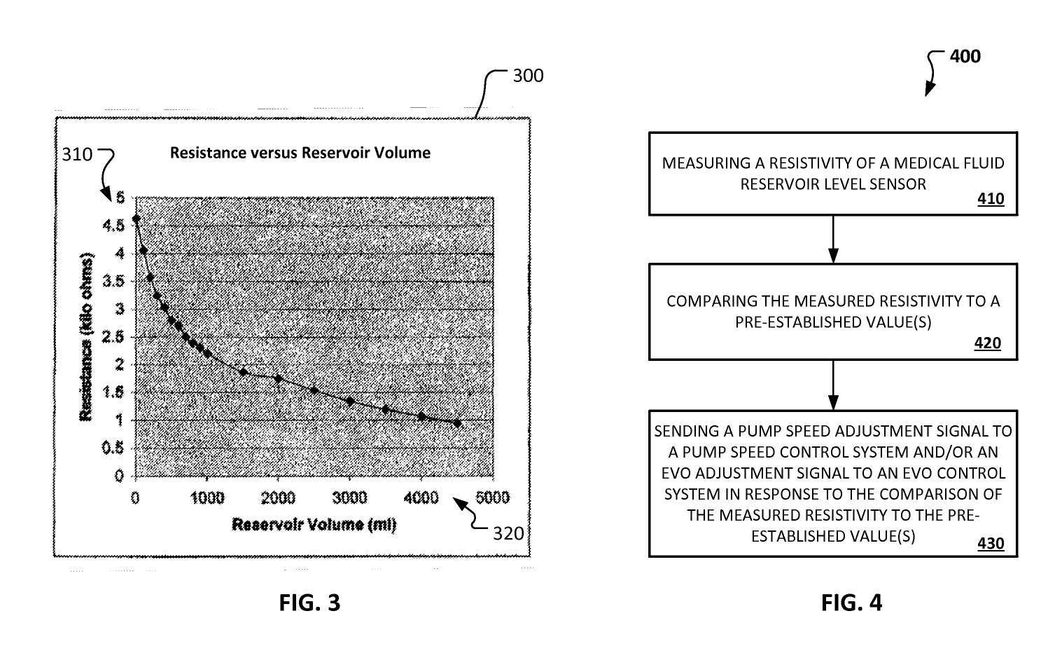

Referring now to FIG. 3, a chart 300 illustrates an example relationship between the resistance of a level sensor 310 (on the y-axis) and the reservoir volume 320 (on the x-axis). It should be understood that the example chart 300 is specific to a particular configuration of a reservoir and a level sensor. Other configurations of reservoirs and level sensors may have a somewhat different relationship, but the fundamental concept of the relationship therebetween will remain the same as illustrated in the chart 300. That fundamental concept is that as the level of electrolytic liquid in the reservoir increases, the resistivity of the level sensor decreases. It is also true that as the level of electrolytic liquid in the reservoir decreases, the resistivity of the level sensor increases. In other words, there is an inverse relationship between the level of electrolytic liquid in the reservoir and the resistivity of the level sensor.

When the reservoir is uniform (e.g., a cylinder), the relationship between the level of electrolytic liquid in the reservoir and the resistivity of the level sensor will be substantially linear. However, when the reservoir is non-uniform (e.g., reservoir 120 of FIGS. 1 and 2A) the relationship between the level of electrolytic liquid in the reservoir and the resistivity of the level sensor will be non-linear.

Referring now to FIG. 4, an example method 400 for using a medical fluid reservoir level sensor to adjust the speed of a pump and/or occlusion of an EVO is provided. For example, the method 400 can be used in the context of a medical fluid circuit such as the extracorporeal blood flow circuit 100 of FIG. 1 that includes reservoir 120, level sensor 124, and pump 130.

At operation 410, the resistivity of the level sensor is measured. As described above, the resistivity of the level sensor is indicative of the level of fluid in the reservoir. For example, a low level of fluid will cause the resistivity of the level sensor to be increased, while a higher level of fluid will cause the resistivity of the level sensor to be decreased. Therefore, the resistivity of the level sensor provides an indication of the level of fluid in the reservoir.

At operation 420, the measured resistivity of the level sensor from operation 410 is compared to a pre-established value or range of values. The pre-established value or range of values may reflect, for example, the resistivity of the level sensor that corresponds to a desired level of liquid to be maintained in the fluid reservoir. By performing the comparison, a deviation in the fluid level from the desired level can be identified.

At operation 430, a pump speed adjustment signal may be sent to a pump speed control system in response to the comparison of operation 420. For example, if the comparison of operation 420 indicates that the measured resistivity of the level sensor is higher than the pre-established value or range of values (indicating a liquid level that is lower than desired), a pump speed adjustment signal to reduce the speed of the pump is sent to the pump speed control system. Conversely, if the comparison of operation 420 indicates that the measured resistivity of the level sensor is lower than the pre-established value or range of values (indicating a liquid level that is higher than desired), a pump speed adjustment signal to increase the speed of the pump is sent to the pump speed control system.

Alternatively or additionally at operation 430, an EVO occlusion adjustment signal may be sent to an EVO control system in response to the comparison of operation 420. For example, if the comparison of operation 420 indicates that the measured resistivity of the level sensor is higher than the pre-established value or range of values (indicating a liquid level that is lower than desired) an EVO occlusion adjustment signal to decrease the percent occlusion may be sent to the EVO control system. Conversely, if the comparison of operation 420 indicates that the measured resistivity of the level sensor is lower than the pre-established value or range of values (indicating a liquid level that is higher than desired) an EVO occlusion adjustment signal to increase the percent occlusion may be sent to the EVO control system.

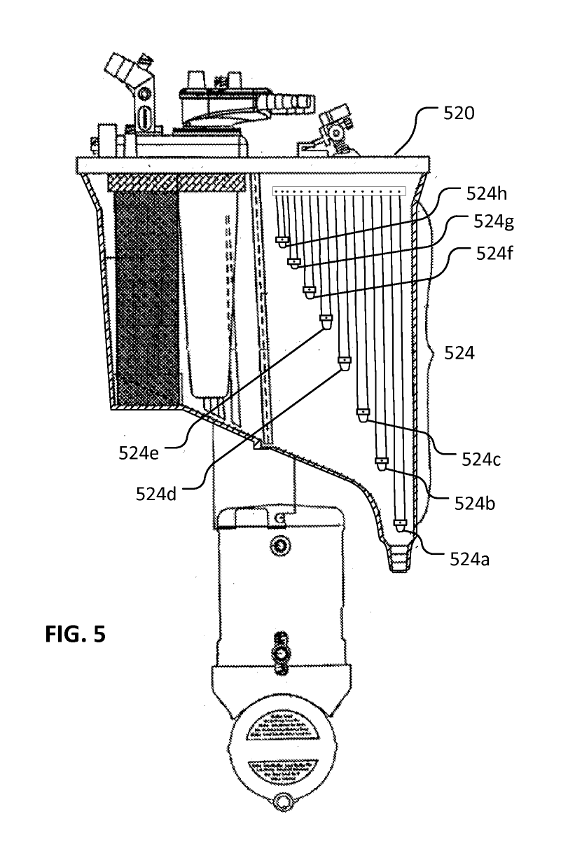

Referring now to FIG. 5, another example level sensor system 524 can be configured at least partially within the interior of a reservoir 520. In this configuration, at least some of the level sensor system 524 can be in direct contact with the liquid contents of the reservoir 520 (such as blood, saline, or other medical fluids). The reservoir 520 of FIG. 5 is shown in a partial cross-sectional view to provide visualization of the interior of the reservoir 520.

The level sensor system 524 includes two or more individual level sensors that are each configured like the level sensor 124 as described above. In the depicted embodiment, the level sensor system 524 includes eight individual level sensors 524a, 524b, 524c, 524d, 524e, 524f, 524g, and 524h. While the depicted embodiment includes eight level sensors, in some embodiments two, three, four, five, six, seven, nine, ten, or more than ten individual level sensors are included in the level sensor system 524.

As described above in reference to the wire loop 125 of level sensor 124, the resistivity of the individual level sensors 524a, 524b, 524c, 524d, 524e, 524f, 524g, and 524h will fluctuate in response to a level of fluid within the reservoir 520. Therefore, in a first operational mode, the level sensor system 524 can be operated in a manner that is analogous to that of the level sensor 124 as described above.

However, the level sensor system 524, with its multiple individual level sensors 524a, 524b, 524c, 524d, 524e, 524f, 524g, and 524h, also facilitates a second operational mode that can function as follows.

As depicted in FIG. 3, in some implementations the greatest rate of resistance change of the level sensors occurs when the liquid in the reservoir is low in relation to the level sensor. Note, for example, that the slope of the curve is steepest at low reservoir volume levels. In fact, an even more significant and detectable level sensor resistance fluctuation may be exhibited just as the level of the liquid falls completely below the lower-most end of an individual level sensor. In such a scenario, an abrupt increase in the resistance of the individual level sensor may be manifested as the level of the liquid falls completely below the end of the individual level sensor. The level sensor system 524 advantageously utilizes the fact that an abrupt increase in level sensor resistance may be manifested as the level of the liquid falls completely below the lower-most end of an individual level sensor. Still referring to FIG. 5, each of the individual level sensors 524a, 524b, 524c, 524d, 524e, 524f, 524g, and 524h has a different length. Therefore, the lower-most ends of the individual level sensors 524a, 524b, 524c, 524d, 524e, 524f, 524g, and 524h are positioned at differing depth levels within the reservoir 520. For example, of all of the individual level sensors 524a, 524b, 524c, 524d, 524e, 524f, 524g, and 524h, the level sensor 524a extends to the lowest depth level within the reservoir 520. In contrast, of all of the individual level sensors 524a, 524b, 524c, 524d, 524e, 524f, 524g, and 524h, the level sensor 524h extends to the highest depth level within the reservoir 520. The other individual level sensors 524b, 524c, 524d, 524e, 524f, 524g extend to various depth levels between those of level sensors 524a and 524h. In other words, as explained further below, the lower-most ends of the individual level sensors 524a, 524b, 524c, 524d, 524e, 524f, 524g, and 524h provide a graduated level sensor system 524 for indicating the level of a liquid within the reservoir 520.

When each individual level sensor 524a, 524b, 524c, 524d, 524e, 524f, 524g, and 524h exhibits a resistance that indicates that each individual level sensor 524a, 524b, 524c, 524d, 524e, 524f, 524g, and 524h is in contact with liquid, it can be determined that the level of the liquid is at or above the lower-most end of level sensor 524h. In such a scenario, a speed of a pump that draws the liquid from the reservoir 520 can be sped up so as to lower the level of the liquid, for example and/or the occlusion of an EVO that allows the liquid into the reservoir 520 can be increased so as to lower the level of the liquid, for example.

When each individual level sensor 524a, 524b, 524c, 524d, 524e, 524f, 524g, and 524h exhibits a resistance that indicates that each individual level sensor 524a, 524b, 524c, 524d, 524e, 524f, 524g, and 524h is out of contact with liquid, it can be determined that the level of the liquid is below the lower-most end of level sensor 524a. In such a scenario, a speed of a pump that draws the liquid from the reservoir 520 can be slowed or stopped so as to increase the level of the liquid, for example and/or the occlusion of an EVO that allows the liquid into the reservoir 520 can be decreased so as to increase the level of the liquid, for example.

One of skill in the art will recognize how the resistances of the individual level sensors 524a, 524b, 524c, 524d, 524e, 524f, 524g, and 524h can be compared to each other to ascertain the level of the liquid when the level is between the lower-most ends of level sensors 524a and 524h. For example, in some implementations the resistances of adjacent individual level sensors 524a, 524b, 524c, 524d, 524e, 524f, 524g, and 524h can be compared to each other. When the difference between the resistances of particular adjacent individual level sensors (e.g., 524a and 524b, or 524b and 524c, or 524c and 524d, or 524d and 524e, or 524e and 524f, or 524f and 524g, or 524g and 524h) is greater than a threshold level, it can be determined that the level of the liquid is between the lower-most ends of those particular adjacent individual level sensors 524a, 524b, 524c, 524d, 524e, 524f, 524g, and 524h. In the second operational mode of the level sensor system 524, such a determination that the level of the liquid is between the lower-most ends of particular adjacent individual level sensors 524a, 524b, 524c, 524d, 524e, 524f, 524g, and 524h can be used to control a fluid system (e.g., controlling the speed of a pump and/or occlusion of an EVO that adds liquid to, or draws liquid from, the reservoir 520).

In some implementations, both the first operational mode and the second operation mode of level sensor system 520 are used in conjunction with each other. For example, in some implementations the second operational mode is used to indicate the particular adjacent individual level sensors 524a, 524b, 524c, 524d, 524e, 524f, 524g, and 524h the liquid level is between the lower-most ends. For illustration, imagine that the second operational mode indicates that the liquid level is between the lower-most ends of level sensors 524f and 524e. In other words, the resistance of level sensor 524f is greater than the resistance of level sensor 524e by a threshold value or more. Such a condition indicates that the liquid level is somewhere between the lower-most ends of level sensors 524f and 524e. In addition, in some implementations the first operation mode can be used to more precisely determine where the liquid level is. In other words, the resistance of level sensor 524e can be compared to a known resistance curve for level sensor 524e, and the liquid level can be determined as a result.

In some implementations, devices for detecting a level of a fluid in a medical fluid reservoir can enable a controller 200 to interface with an EVO 190 to control venous blood flow (drainage) from the heart 12 to the reservoir 120 (refer to FIG. 1). Level sensor 524a extends to the lowest depth level within the reservoir 520. When the resistance in level sensor 524a is high, the reservoir fluid level is low, a signal from the controller 200 decreases the EVO occlusion (increased venous tube 110 internal diameter), allowing maximal venous blood flow (drainage) from the heart 12 to the reservoir 120. Level sensor 524h extends to the highest depth level within the reservoir 520. When the resistance in level sensor 524h is low, the reservoir fluid level is high, a signal from the controller 200 increases the EVO occlusion (decreased venous tube 110 internal diameter), allowing minimal venous blood flow (drainage) from the heart 12 to the reservoir 120. Fluid level sensor signals the controller 200 of the EVO 190 to prevent the over flow of the medical reservoir with the patient's blood, thereby, preventing unwanted blood loss.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

1.-14. (canceled)

15. A medical fluid reservoir comprising:
a reservoir shell defining an interior space that is configured to receive a medical fluid; and
two or more individual level sensors at least partially disposed in the interior space, each of the two or more individual level sensors comprising a wire that is configured to be immersed in the medical fluid such that a resistivity of the wire is indicative of a level of the medical fluid in the interior space.

16. The medical fluid reservoir of claim 15, wherein the wire is a loop, and wherein an amount of the wire loop that is immersed in the medical fluid corresponds to the resistivity of the wire loop.

17. The medical fluid reservoir of claim 16, wherein the amount of the wire loop that is immersed in the medical fluid is inversely proportional to the resistivity of the wire loop.

18. The medical fluid reservoir of claim 16, wherein the medical fluid is an electrolyte.

19. The medical fluid reservoir of claim 18, wherein the medical fluid comprises human blood.

20. The medical fluid reservoir of claim 15, wherein the two or more individual level sensors comprises three or more individual level sensors, the three or more individual level sensors having differing lengths.

21. The medical fluid reservoir of claim 15, wherein the two or more individual level sensors comprises five or more individual level sensors, the five or more individual level sensors having differing lengths.

22. A method of controlling a medical pump, wherein the method comprises:
measuring a resistivity of two or more individual level sensors at least partially disposed in an interior space of a reservoir containing a medical fluid, each of the two or more individual level sensors comprising a wire that is configured to be immersed in the medical fluid such that a resistivity of the wire is indicative of a level of the medical fluid in the interior space;
comparing the measured resistivity of adjacent individual level sensors of the two or more individual level sensors to determine a resistivity difference between adjacent individual level sensors;
comparing the determined resistivity difference between adjacent individual level sensors to a pre-established threshold value or range of resistivity;
determining the level of the medical fluid in the interior space based on a particular resistivity difference between adjacent individual level sensors being greater than the pre-established threshold value or range of resistivity; and
in response to the determining, sending a pump speed adjustment signal to a pump speed control system that controls the speed of the medical pump that propels the medical fluid.

23. The method of claim 22, wherein the wire is a loop, and wherein an amount of the wire loop that is immersed in the medical fluid corresponds to the resistivity of the wire loop.

24. The method of claim 23, wherein the amount of the wire loop that is immersed in the medical fluid is inversely proportional to the resistivity of the wire loop.

25. The method of claim 22, wherein the medical fluid is an electrolyte.

26. The method of claim 25, wherein the medical fluid comprises human blood.

27. The method of claim 22, wherein the two or more individual level sensors comprises three or more individual level sensors.

28. The method of claim 22, wherein the two or more individual level sensors comprises five or more individual level sensors.

29. A medical fluid system comprising:
a reservoir shell defining an interior space that is configured to receive a medical fluid;
two or more individual level sensors at least partially disposed in the interior space, each of the two or more individual level sensors comprising a wire that is configured to be immersed in the medical fluid such that a resistivity of the wire is indicative of a level of the medical fluid in the interior space; and
a pump system that is configured to pump the medical fluid into or out of the interior space, wherein a speed of the pump system is responsive to a pump speed adjustment input signal.

30. The medical fluid system of claim 29, wherein the wire is a loop, and wherein an amount of the wire loop that is immersed in the medical fluid corresponds to the resistivity of the wire loop.

31. The medical fluid system of claim 30, wherein the amount of the wire loop that is immersed in the medical fluid is inversely proportional to the resistivity of the wire loop.

32. The medical fluid system of claim 31, wherein, in response to a decreased resistivity of the wire loop, the pump speed adjustment input signal causes the speed of the pump system to increase.

33. The medical fluid system of claim 31, wherein, in response to an increased resistivity of the wire loop, the pump speed adjustment input signal causes the speed of the pump system to decrease.

34. The medical fluid system of claim 29, wherein the two or more individual level sensors comprises three or more individual level sensors, the three or more individual level sensors having differing lengths.
